(19) United States
(12) Patent Application Publication
(10) Pub. No.: US 2026/0046240 A1
(43) Pub. Date: Feb. 12, 2026

(54) OVERLAY NETWORK LOOP DETECTION AND PREVENTION

(71) Applicant: Cisco Technology, Inc., San Jose, CA (US)

(72) Inventors: Makesh Srinivasan, Bangalore (IN); Sanjay Kumar Hooda, Pleasanton, CA (US); Senthil Kumar Chandramohan, Bangalore (IN); Prakash C. Jain, Fremont, CA (US)

(21) Appl. No.: 18/798,206

(22) Filed: Aug. 8, 2024

(51) Int. Cl. H04L 45/18; H04L 12/44; H04L 41/122; H04L 45/64

(52) U.S. Cl. CPC H04L 45/18; H04L 12/44; H04L 41/122; H04L 45/64

(57) ABSTRACT

Techniques described herein can detect and disable loops involving fabric overlay networks. A loop can occur when a fabric overlay network is coupled with two or more external data link layer switches, and the fabric overlay network and the data link layer switches are configured to forward network packets in multiple redundant traverses of the fabric overlay network and the data link layer switches. In response to detecting a loop, the loop can be disabled by modifying at least one fabric edge component of the fabric overlay network. The fabric edge component can be reconfigured to block network packets communicated between the fabric edge component and at least one of the data link layer switches.

### TECHNICAL FIELD

The present disclosure relates generally to computing network communications, and to communications involving overlay networks in particular.

### BACKGROUND

A network loop is an undesired condition in computer network traffic, in which data packets circulate endlessly among a group of network entities, potentially leading to congestion and network collapse. Traditional data link layer networks, such as Layer-2 Ethernet networks, lacked native loop detection and mitigation, and so various solutions were developed to prevent loops in traditional data link layer networks.

In contrast, modern overlay networks have mostly addressed the problem of network loops by inherently creating loop-free topologies. However, in some instances loops can occur when a modern overlay network operates in conjunction with legacy data link layer equipment.

Loops in networks can present a significant problem. Loops can cause indefinite data frame existence, disrupting network stability and degrading network performance. Furthermore, loops can introduce broadcast radiation and can increase central processing unit (CPU) and network bandwidth usage, leading to degraded user application experiences.

In view of the above, loop detection and prevention techniques are needed to prevent network loops involving modern overlay networks and legacy data link layer equipment.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example architecture comprising multiple networked entities, the multiple networked entities including a fabric overlay network, a first data link layer switch, and a second data link layer switch, wherein a loop can exist among multiple networked entities, in accordance with various aspects of the technologies disclosed herein.

FIG. 2 illustrates a first example architecture to detect and disable loops, in accordance with various aspects of the technologies disclosed herein.

FIG. 3 illustrates a second example architecture to detect and disable loops, in accordance with various aspects of the technologies disclosed herein.

FIG. 4 illustrates example data structures used in accordance with the second example architecture illustrated in FIG. 3, in accordance with various aspects of the technologies disclosed herein.

FIG. 5 illustrates a third example architecture to detect and disable loops, in accordance with various aspects of the technologies disclosed herein.

FIG. 6 illustrates example data structures used in accordance with the third example architecture illustrated in FIG. 5, in accordance with various aspects of the technologies disclosed herein.

FIG. 7 illustrates example controller components and example fabric edge node components, in accordance with various aspects of the technologies disclosed herein.

FIG. 8 illustrates an example packet switching system that can be utilized to implement devices in accordance with various aspects of the technologies disclosed herein.

FIG. 9 illustrates an example node that can be utilized to implement devices in accordance with various aspects of the technologies disclosed herein.

FIG. 10 illustrates an example computer hardware architecture that can implement devices in accordance with various aspects of the technologies disclosed herein.

FIG. 11 is a flow diagram that illustrates an example overlay network loop detection and prevention method, in accordance with various aspects of the technologies disclosed herein.

### DESCRIPTION OF EXAMPLE EMBODIMENTS

### Overview

This disclosure describes techniques that can be performed in connection with overlay network loop detection and prevention. Example techniques can include detecting a loop among multiple networked entities, the multiple network entities comprising a fabric overlay network, a first data link layer switch, and a second data link layer switch. The first data link layer switch and the second data link layer switch may be coupled externally of the fabric overlay network, and the loop can enable forwarding network packets in multiple redundant traverses of the fabric overlay network, the first data link layer switch, and the second data link layer switch. In response to detecting the loop, at least one fabric edge component of the fabric overlay network can be modified to disable the loop. The modifying can comprise reconfiguring the at least one fabric edge component to block network packets communicated between the fabric edge component and, e.g., the first data link layer switch.

The techniques described herein may be performed by one or more computing devices comprising one or more processors and one or more computer-readable media storing computer-executable instructions that, when executed by the one or more processors, cause the one or more processors to perform the methods disclosed herein. The techniques described herein may also be accomplished using non-transitory computer-readable media storing computer-executable instructions that, when executed by one or more processors, perform the methods carried out by the network controller device.

### Example Embodiments

In an example according to this disclosure, loops involving fabric overlay networks can be detected and disabled. A fabric overlay network is defined herein as both a fabric and an overlay. A fabric can provide a collection of interconnected leaf layer nodes and spine layer nodes. The fabric nodes form a scalable, resilient and high performance network architecture. An overlay network can provide a logical topology used to virtually interconnect devices. An overlay network can be built on top of a physical underlay topology which is abstracted by the overlay. The overlay can optionally provide services which are not directly provided by the underlay.

Overlay networks can be classified as layer two (L2) or layer three (L3) overlays. L3 fabric overlay network designs can be based on routing protocols such as open shortest path first (OSPF) and border gateway protocol (BGP). L2 fabric overlay network designs use technologies such as transparent interconnection of lots of links (TRILL), shortest-path bridging (SPB), and virtual extensible local area network (VXLAN).

L3 fabrics are easier to troubleshoot and offer better scalability and more predictability on the traffic flows through the fabric, but they don't inherently provide L2 connectivity. L2 connectivity is often a requirement imposed by business applications derived from application workflows or virtualization environments.

Spanning tree protocols (STPs) were developed to counteract loops in early L2 ethernet networks. Networks subsequently evolved to “loop-free” topologies, reducing dependence on loop prevention protocols. Network fabric overlays such as VXLAN ethernet virtual private network (EVPN) and locator/ID separation protocol (LISP) VXLAN have mostly eliminated the need for loop prevention.

However, reliable loop detection remains valuable, because external topologies connected to fabric overlay networks can introduce loops. For example, in fabric overlay networks, L2 broadcast and multicast (BUM) packets may be forwarded in the network using underlay multicast. Underlay multicast does not have the ability to detect L2 loops. Loops can result, creating undue stress on network devices and eventually leading to network outages.

In an example according to this disclosure, a loop can occur among multiple networked entities, such as a fabric overlay network coupled with two or more external data link layer switches. The external data link layer switches can comprise, e.g., ethernet switches. In a loop configuration, the fabric overlay network and the data link layer switches are configured to forward network packets in multiple redundant traverses of the fabric overlay network and the data link layer switches. In response to detecting a loop, the loop can be disabled by modifying at least one fabric edge component of the fabric overlay network. The fabric edge component can be reconfigured to block network packets communicated between the fabric edge component and at least one of the data link layer switches.

Three example approaches to loop detection are described herein. In a first example approach, detecting the loop among the multiple networked entities can comprise sending, by fabric edge components, spanning tree topology information to a fabric overlay network controller, wherein the fabric overlay network controller is configured to detect the loop based on the spanning tree topology information. The spanning tree topology information can comprise a bridge identifier associated with each fabric edge component and a virtual local area network identifier associated with each fabric edge component. The fabric overlay network controller can be adapted to detect the loop based on the spanning tree topology information by comparing the spanning tree topology information received from multiple different fabric edge components of the fabric overlay network.

In a second example approach to loop detection, detecting the loop among the multiple networked entities can comprises sending, by each fabric edge component, bridge protocol data unit (BDPU) information to a control plane node associated with the fabric overlay network. The control plane node can be configured to detect the loop based on a comparison of the BDPU received from multiple different fabric edge components of the fabric overlay network.

In a third example approach to loop detection, detecting the loop among the multiple networked entities can comprise detecting the loop based on a comparison of media access control (MAC) information included in user plane data packets processed by the fabric edge components of the fabric overlay network.

Regardless of the approach applied to detect potential loop conditions, the entity that performed the detection, e.g., the fabric overlay network controller or the control plane node, can be adapted to disable the loop. In an example, disabling the loop can comprise reconfiguring at least one fabric edge component to block network packets communicated between the fabric edge component and one or more of the data link layer switches involved in the loop. The fabric edge component can be reconfigured by blocking a port of the at least one fabric edge component.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

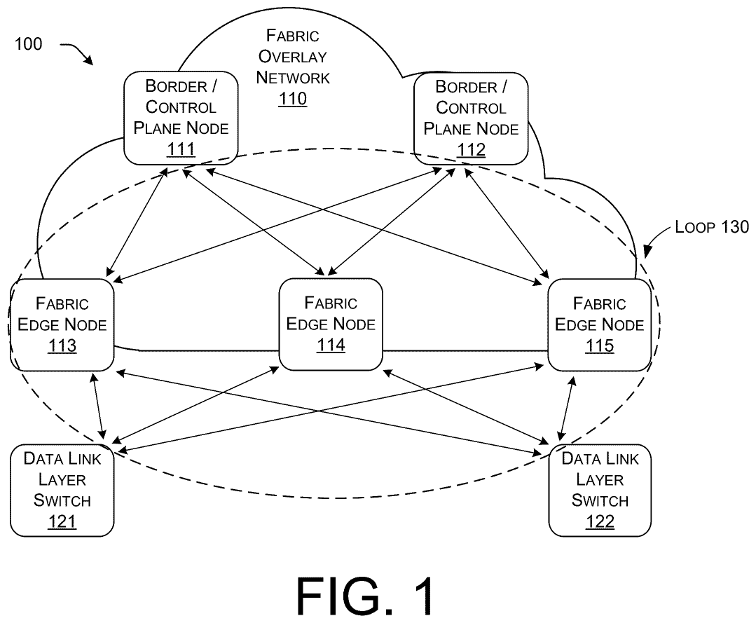

FIG. 1 illustrates an example architecture 100 comprising multiple networked entities, the multiple networked entities including a fabric overlay network 110, a first data link layer switch 121, and a second data link layer switch 122, wherein a loop 130 can exist among multiple networked entities, in accordance with various aspects of the technologies disclosed herein.

In FIG. 1, the fabric overlay network 110 comprises multiple nodes, e.g., border/control plane nodes such as 111 and 112, and fabric edge nodes such as 113, 114, and 115. The border/control plane nodes 111, 112 and the fabric edge nodes 113, 114, 115 are part of the fabric overlay network 110, while the first data link layer switch 121 and the second data link layer switch 122 are coupled externally of the fabric overlay network 110.

The loop 130 results from configurations of the fabric overlay network 110, the first data link layer switch 121 and the second data link layer switch 122, and the loop 130 enables forwarding network packets in multiple redundant traverses of the fabric overlay network 110, the first data link layer switch 121, and the second data link layer switch 122. The loop 130 is considered an undesirable condition to be detected and disabled according to the techniques described herein.

The various entities illustrated in FIG. 1 can communicate according to different communication paths, illustrated by two-way arrows. For example, the first data link layer switch 121 and the second data link layer switch 122 can each communicate with any of the fabric edge nodes 113, 114, 115. The fabric edge nodes 113, 114, 115 can each communicate with any of the border/control plane nodes 111, 112.

The fabric overlay network 110 can be configured in a variety of ways, and this disclosure is not limited to any particular configuration. In general, the fabric overlay network 110 can be configured as both a fabric and an overlay. As described herein, fabric can provide a collection of interconnected leaf layer nodes and spine layer nodes. The fabric nodes form a scalable, resilient and high performance network architecture. An overlay network can provide a logical topology used to virtually interconnect devices. An overlay network can be built on top of a physical underlay topology which is abstracted by the overlay. The overlay can optionally provide services which are not directly provided by the underlay.

The fabric overlay network 110 can be configured as a layer two (L2) or layer three (L3) overlay. Furthermore, the techniques described herein are applicable to network fabric overlays such as VXLAN EVPN and LISP VXLAN. Meanwhile, the first data link layer switch 121, and the second data link layer switch 122 can be implemented as ethernet switches in some embodiments.

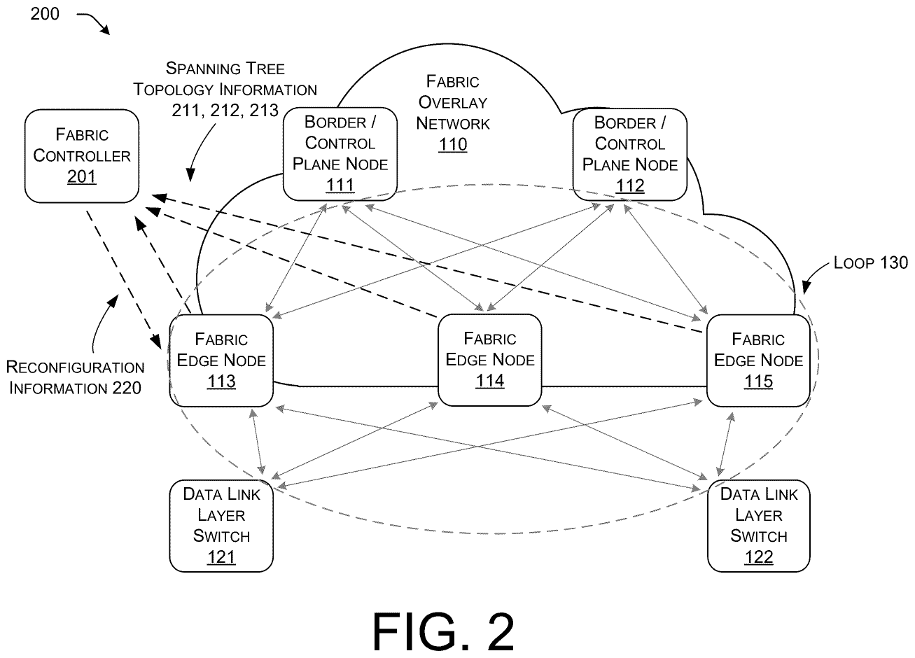

FIG. 2 illustrates a first example architecture 200 to detect and disable loops, in accordance with various aspects of the technologies disclosed herein. The example architecture 200 comprises the elements introduced in FIG. 1, namely, the fabric overlay network 110, the first data link layer switch 121, and the second data link layer switch 122, wherein the fabric overlay network 110 comprises border/control plane nodes 111, 112 and fabric edge nodes 113, 114, 115. The example architecture 200 furthermore illustrates a fabric controller 201 which can be configured to detect and disable loops according to embodiments of this disclosure.

In general, with reference to FIG. 2, a spanning tree topology based detection approach is illustrated in which one or more of the fabric edge nodes 113, 114, 115 are configured to report spanning tree topology information 211, 212, 213 to the fabric controller 201. The fabric controller 201 is configured to perform loop detection based at least in part on the spanning tree topology information 211, 212, 213 received from the fabric edge nodes 113, 114, 115.

In response to detecting a loop 130, the fabric controller 201 can configure and send reconfiguration information 220 to a fabric edge node 113 that is included in the loop 130. The reconfiguration information 220 can reconfigure the fabric edge node 113 in a manner that disables the loop 130, for example by blocking a port used by the fabric edge node 113 in connection with the loop 130.

In examples according to FIG. 2, in response to connection of the first data link layer switch 121 and/or the second data link layer switch 122 to the fabric overlay network 110, BPDUs can be sent to the fabric overlay network 110 for allowed VLANs. A first example allowed VLAN can be enabled by fabric edge node 113 and the first data link layer switch 121, and a second example allowed VLAN can be enabled by fabric edge node 115 and the second data link layer switch 122.

The fabric edge nodes 113, 114, 115 can share spanning tree topology information 211, 212, 213 to the fabric controller 201. Example spanning tree topology information 211 collected by fabric edge node 113 on the first data link layer switch 121 can provide a bridge identifier (ID) and a VLAN ID associated with the first data link layer switch 121. Similarly, example spanning tree topology information 213 collected by fabric edge node 115 on the second data link layer switch 122 can provide a bridge ID and a VLAN ID associated with the second data link layer switch 122.

The fabric controller 201 can be configured to perform a loop detection process on the received spanning tree topology information 211, 212, 213. The loop detection process can compare spanning tree topology information 211, 212, 213 received from different fabric edge nodes 113, 114, 115, to identify if there is an identical {Bridge ID: VLAN} data combination from two different fabric edge nodes, e.g., from fabric edge node 113 and fabric edge node 115. If such identical data is identified, the fabric controller 201 can infer that a loop 130 is present.

In response to detecting a loop 130, the fabric controller 201 can apply a loop disabler process to disable the detected loop 130. For example, one or more of the BPDU receive interfaces of the fabric edge nodes 113, 115 can be error disabled or blocked by the fabric controller 201. In the scenario illustrated in FIG. 2, the fabric controller 201 can send reconfiguration information 220 to the fabric edge node 113. The reconfiguration information 220 can block fabric edge node 113's BPDU received port.

In some embodiments, in further response to detecting a loop 130, an assurance process for the fabric overlay network 110 can generate an alert for a layer-2 loop involving data link layer switches. The assurance process can further provide a visual/database of layer-2 network as it is connected to the fabric overlay network 110. The assurance process can further continue to monitor BPDUs on fabric edge nodes 113, 115 involved in the loop 130. When there is no BPDU received for a given period, on the fabric edge node 113's BPDU received interface due to link failure, a self-healing engine of the assurance process can trigger the fabric edge node 113's control plane to release/restore the disabled port.

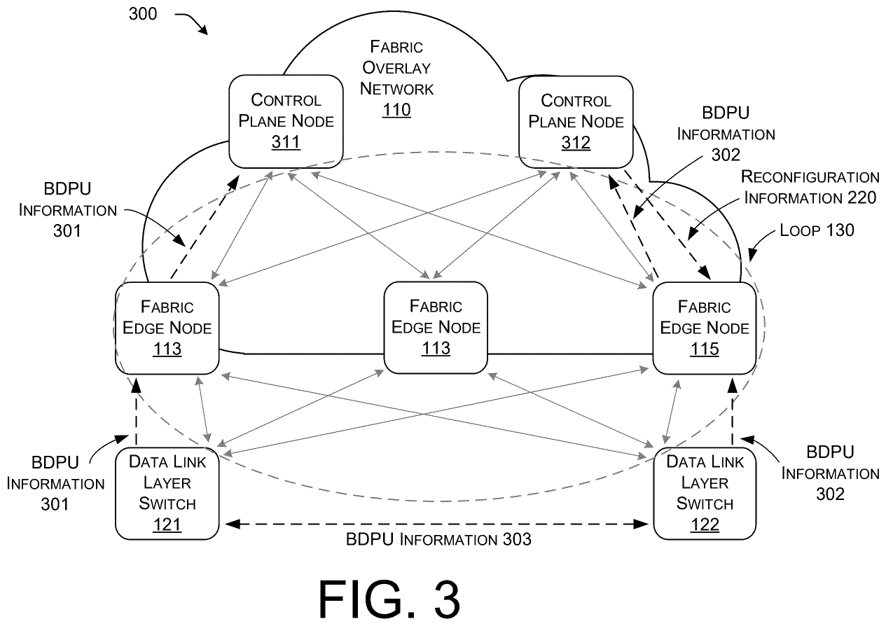

FIG. 3 illustrates a second example architecture 300 to detect and disable loops, in accordance with various aspects of the technologies disclosed herein. The example architecture 300 comprises the elements introduced in FIG. 1, namely, the fabric overlay network 110, the first data link layer switch 121, and the second data link layer switch 122, wherein the fabric overlay network 110 comprises fabric edge nodes 113, 114, 115. In FIG. 3, the border/control plane nodes 111, 112 of FIG. 1 are replaced by control plane nodes 311, 312. Any border node functionality may but need not necessarily be included in the control plane nodes 311, 312. A control plane implemented in part by the control plane nodes 311, 312 can be configured to detect and disable loops according to embodiments of this disclosure.

In general, with reference to FIG. 3, a BDPU or control plane based detection approach is illustrated in which one or more of the fabric edge nodes 113, 114, 115 are configured to report BDPU information 301, 302 to the control plane nodes 311, 312. In FIG. 3, the fabric edge nodes 113, 115 are illustrated as reporting BDPU information 301, 302. The control plane nodes 311, 312 can be configured to perform loop detection based at least in part on the BDPU information 301, 302 received from the fabric edge nodes 113, 114, 115. The first data link layer switch 121 and the second data link layer switch 122 may also exchange BDPU information 303.

In response to detecting a loop 130, the control plane nodes 311, 312 can configure and send reconfiguration information 220 to a fabric edge node 115 that is included in the loop 130. The reconfiguration information 220 can reconfigure the fabric edge node 115 in a manner that disables the loop 130, for example by blocking a port used by the fabric edge node 115 in connection with the loop 130.

In examples according to FIG. 3, in response to connection of the first data link layer switch 121 and/or the second data link layer switch 122 to the fabric overlay network 110, BPDU information 301, 302 can be sent to the fabric overlay network 110 for allowed VLANs. A first example allowed VLAN can be enabled by fabric edge node 113 and the first data link layer switch 121, and a second example allowed VLAN can be enabled by fabric edge node 115 and the second data link layer switch 122.

Control plane functions of the fabric edge nodes 113, 115 can notify the control plane nodes 311, 312 of the received BPDU information 301, 302. The fabric edge nodes 113, 115 can optionally be configured to include additional information along with the BPDU information 301, 302 sent to the control plane. For example, the fabric edge nodes 113, 115 can optionally include routing locator (RLOC) information and port ID information along with the BPDU information 301, 302 sent to the control plane nodes 311, 312. Such additional information can be sent in a variety of different formats, including vendor specific formats in some embodiments.

In another example, the fabric edge nodes 113, 115 can optionally include a bridge ID of a connected data link layer switch, and a wireless networking tag for the data link layer switch, such as an 802.1q tag. Bridge IDs and VLAN information can be leveraged along with BPDU information for loop detection.

In an example implementation, the first data link layer switch 121 can send BPDU information 301 to fabric edge node 113 and can store L2 data in an L2 bridge table of fabric edge node 113. Fabric edge node 113 can be configured to record and register {Bridge ID: VLAN} information to an overlay control plane L2 table, referred to herein as an L2 bridge table. Likewise, the second data link layer switch 122 can send the BPDU information 302 to fabric edge node 115 and can record and register {Bridge ID: VLAN} information to the overlay control plane in the L2 Bridge Table.

The overlay control plane, implemented via the control plane nodes 311, 312 can be configured to validate/compare incoming {Bridge ID: VLAN} information with existing {Bridge ID: VLAN} information before registering. If any incoming {Bridge ID: VLAN} information is a duplicate from a different data link layer switch, then the control plane nodes 311, 312 can avoid registering the duplicate and can generate a loop detection event. Upon duplicate information detection, the control plane nodes 311, 312 can notify to the sender RLOC to disable a BPDU received port associated with the duplicate {Bridge ID: VLAN} information. The loop detection information can be sent to a controller such as the fabric controller 201 introduced in FIG. 2, and assurance processes can alert for a layer-2 loop involving the data link layer switches.

In some embodiments, in further response to detecting a loop 130, an assurance process for the fabric overlay network 110 can be configured to provide a visual database of a layer-2 network in an overlay network. The assurance process can furthermore continue to monitor BPDUs on fabric edge nodes 113, 115 involved in the loop 130. When there is no BPDU received for a given period, on the fabric edge node 113's BPDU received interface due to link failure, a self-healing engine of the assurance process can trigger the fabric edge node 113's control plane to release/restore the disabled port.

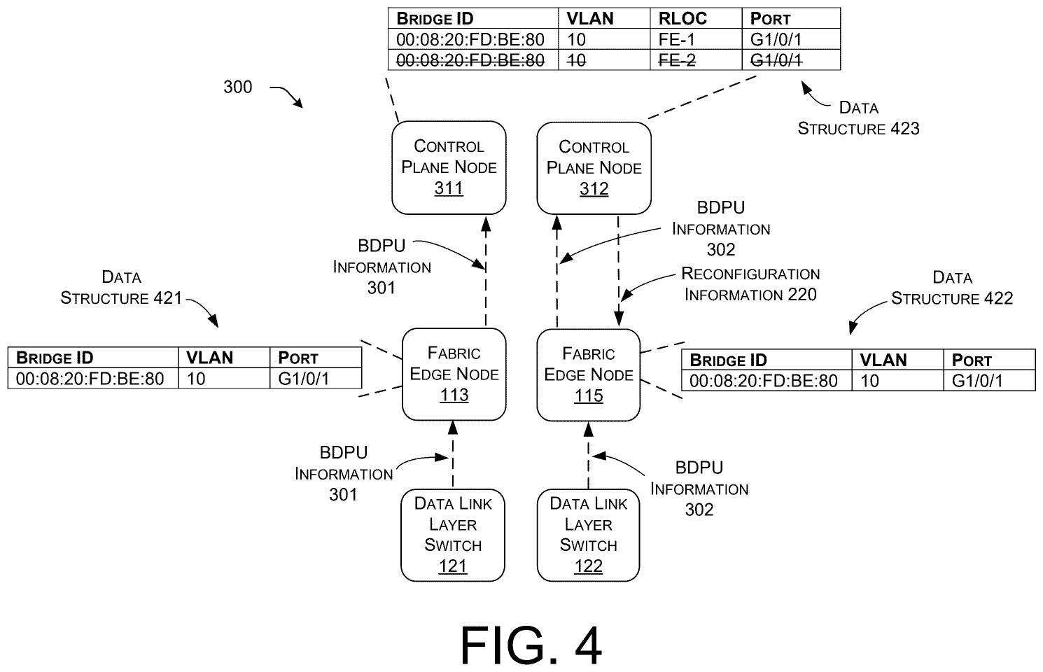

FIG. 4 illustrates example data structures used in accordance with the second example architecture 300 illustrated in FIG. 3, in accordance with various aspects of the technologies disclosed herein. FIG. 4 includes some of the elements introduced in FIG. 3, namely, the control plane nodes 311, 312, the fabric edge nodes 113, 115, and the data link layer switches including the first data link layer switch 121 and the second data link layer switch 122. FIG. 4 further illustrates respective example data structures 421, 422 implemented at respective fabric edge nodes 113, 115. FIG. 4 further illustrates an example data structure 423 implemented at a control plane supported at least in part by the control plane nodes 311, 312.

The data structures 421 and 422 include L2 bridge tables for fabric edge nodes 113 and 115, respectively. The example L2 bridge table of data structure 421 records a bridge ID, VLAN, and port information associated with the first data link layer switch 121, and the example L2 bridge table of data structure 422 records a bridge ID, VLAN, and port information associated with the second data link layer switch 122. In the illustrated example, the data structures 421 and 422 are identical, which can result in a loop being detected.

The fabric edge nodes 113, 115 can be configured to record information in the data structures 421 and 422 to a control plane overlay L2 bridge table, illustrated by data structure 423. The overlay control plane, implemented via the control plane nodes 311, 312 can be configured to compare {Bridge ID: VLAN} entries in the control plane overlay L2 bridge table. If any incoming {Bridge ID: VLAN} information is a duplicate from a different data link layer switch, i.e., as shown in FIG. 4, then the control plane nodes 311, 312 can avoid registering the duplicate and can generate a loop detection event. Upon duplicate information detection, the control plane nodes 311, 312 can generate and send reconfiguration information 220 to disable the loop.

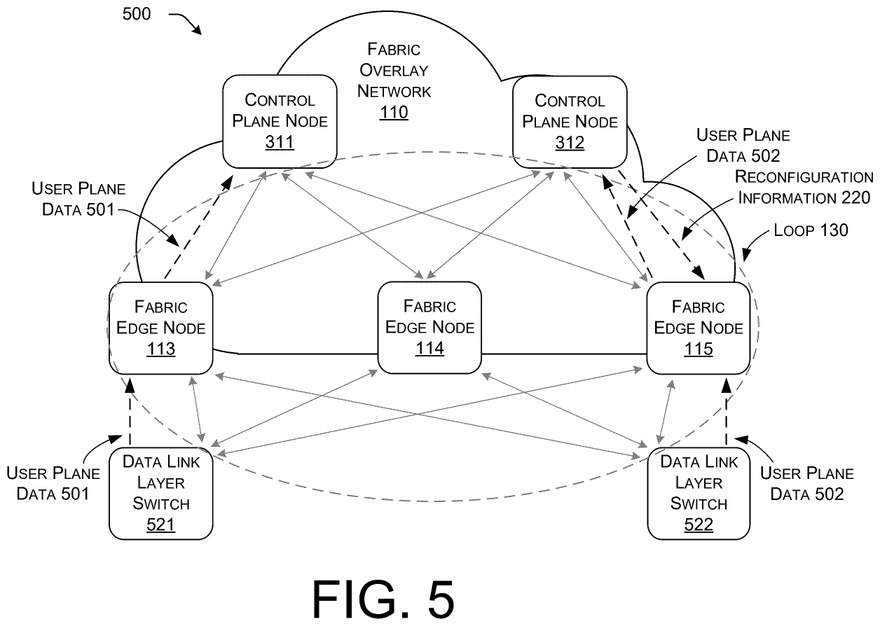

FIG. 5 illustrates a third example architecture 500 to detect and disable loops, in accordance with various aspects of the technologies disclosed herein. The example architecture 500 comprises elements introduced in FIG. 3, namely, the fabric overlay network 110, wherein the fabric overlay network 110 comprises fabric edge nodes 113, 114, 115 and control plane nodes 311, 312. A first data link layer switch 521 and a second data link layer switch 522 illustrated in FIG. 5 can comprise unmanaged switches. A control plane implemented in part by the control plane nodes 311, 312 can be configured to detect and disable loops according to embodiments of this disclosure.

In general, with reference to FIG. 5, a MAC or user plane based detection approach is illustrated in which one or more of the fabric edge nodes 113, 114, 115 are configured to report user plane data 501, 502 to the control plane nodes 311, 312. In FIG. 5, the fabric edge nodes 113, 115 are illustrated as reporting user plane data 501, 502. The control plane nodes 311, 312 can be configured to perform loop detection based at least in part on the user plane data 501, 502 received from the fabric edge nodes 113, 114, 115.

As described in connection with FIG. 3, in response to detecting a loop 130, the control plane nodes 311, 312 can configure and send reconfiguration information 220 to a fabric edge node 115 that is included in the loop 130. The reconfiguration information 220 can reconfigure the fabric edge node 115 in a manner that disables the loop 130, for example by blocking a port used by the fabric edge node 115 in connection with the loop 130.

In examples according to FIG. 5, the unmanaged data link layer switch switches 521, 522 can be connected to the fabric overlay network 110, however, there may not be any BPDU information received at the fabric edge nodes 113, 115. Therefore, embodiments according to FIG. 5 cannot necessarily use BDPU information for loop detection.

In a scenario such as illustrated in FIG. 5, MAC address information may flap back and forth between fabric edge nodes 113, 115. The fabric overlay network 110 control plane, implemented at least in part by control plane nodes 311, 312, can be configured to detect MAC address reassignments and keep a count of MAC address reassignments within a determined time period. A threshold number of MAC address reassignments within the determined time period can be determined to indicate a possible loop in the fabric overlay network 110 across the fabric edge nodes 113, 115. The control plane nodes 311, 312 can be configured to generate a loop detection event and can optionally export the event to a fabric controller such as fabric controller 201, which can use fabric topology information to verify the possible loop 130 and take action, e.g., by generating and sending reconfiguration information 220 to a fabric edge node 115.

The fabric controller 201, which can optionally be included in embodiments according to FIG. 5, can be configured to create a graph of a topology downstream of the fabric edge nodes 113, 115, and check for a looping path between fabric edge nodes 113, 115. Topology data can help to identify the looping interfaces of the fabric edge nodes 113, 115. The fabric controller 201 and/or the control plane nodes 311, 312 can be configured to generate and send reconfiguration information 220 to disable a port/looping interface of one of the fabric edge nodes 113, 115.

Furthermore, in some embodiments, as described in connection with FIG. 2, in further response to detecting a loop 130, an assurance process for the fabric overlay network 110 can be configured to provide a visual database of a layer-2 network in an overlay network. The assurance process can furthermore continue to monitor BPDUs on fabric edge nodes 113, 115 involved in the loop 130. When a monitored fabric edge port is down due to link failure for a determined period, a self-healing engine of the assurance process can trigger the fabric edge node 113's control plane to release/restore the disabled port.

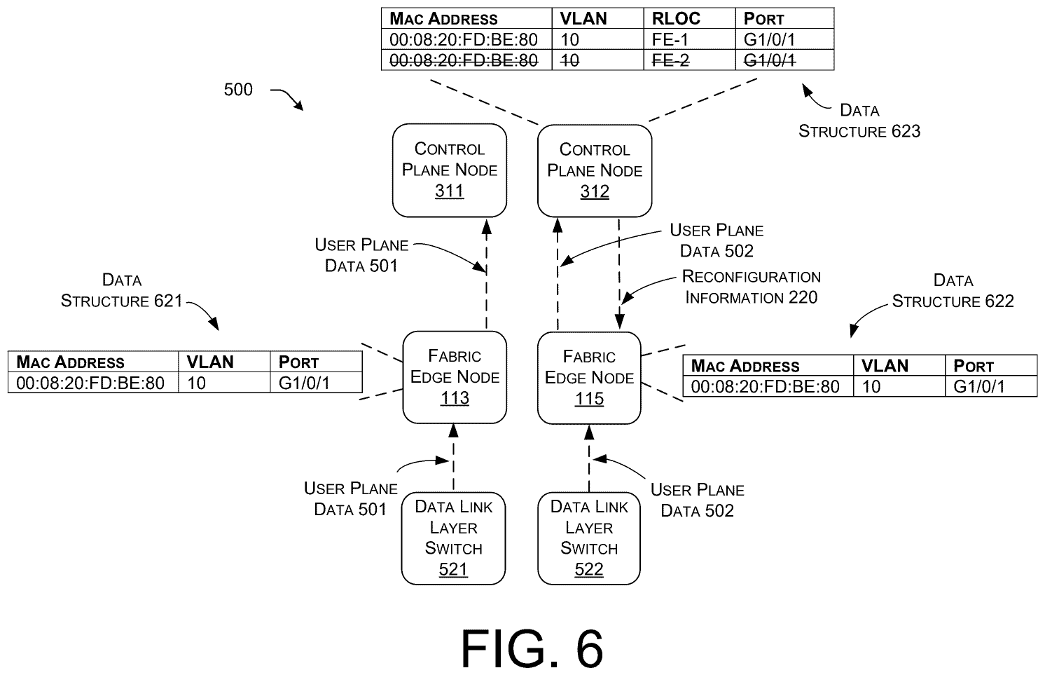

FIG. 6 illustrates example data structures used in accordance with the third example architecture 500 illustrated in FIG. 5, in accordance with various aspects of the technologies disclosed herein. FIG. 6 includes some of the elements introduced in FIG. 5, namely, the control plane nodes 311, 312, the fabric edge nodes 113, 115, and the data link layer switches 521, 522. FIG. 6 further illustrates respective example data structures 621, 622 implemented at respective fabric edge nodes 113, 115. FIG. 6 further illustrates an example data structure 623 implemented on a control plane supported at least on party by the control plane nodes 311, 312.

The data structures 621 and 622 include tables stored or otherwise maintained at fabric edge nodes 113 and 115, respectively. The example data structure 621 records a MAC address, VLAN, and port information associated with the data link layer switch 521, and the example data structure 622 records a MAC address, VLAN, and port information associated with the data link layer switch 522. In the illustrated example, the data structures 621 and 622 are identical, which can result in a loop being detected.

The fabric edge nodes 113, 115 can be configured to record information in the data structures 621 and 622 to a control plane data structure 623. The control plane data structure 623 can comprise MAC address, VLAN, RLOC, and port information The control plane implemented via the control plane nodes 311, 312 can be configured to compare entries in the data structure 623. If any duplicate information is recorded by different fabric edge nodes 113, 115, i.e., as shown in FIG. 6, and as can be determined based on identical MAC addresses recorded with different RLOC information, then the control plane nodes can detect a MAC flap and can keep count of such MAC flaps for loop detection as described in connection with FIG. 5.

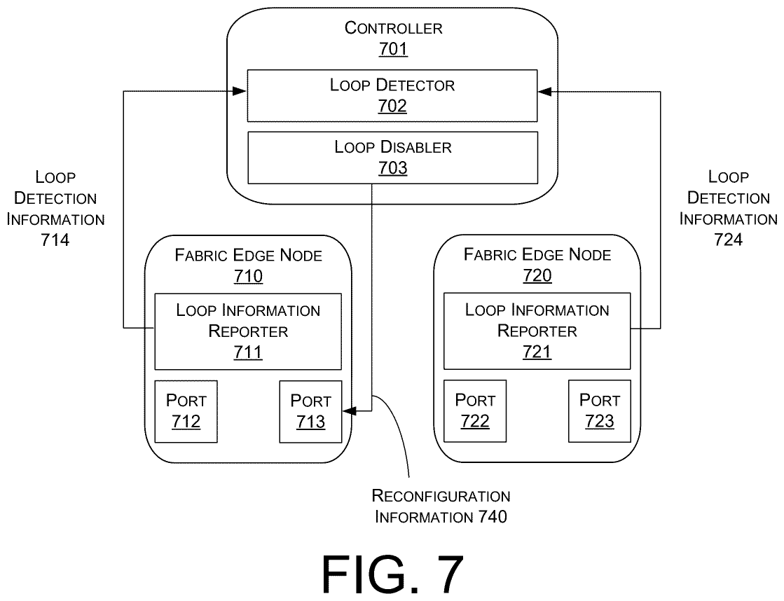

FIG. 7 illustrates example controller components and example fabric edge node components, in accordance with various aspects of the technologies disclosed herein. FIG. 7 includes an example controller 701, an example fabric edge node 710, and an example fabric edge node 720. The example controller 701 comprises a loop detector 702 and a loop disabler 703. The example fabric edge node 710 comprises a loop information reporter 711 and ports 712, 713. The example fabric edge node 720 comprises a loop information reporter 721 and ports 722, 723.

The example controller 701 can implement, e.g., the fabric controller 201 introduced in FIG. 6, or one or more of the control plane nodes 311, 312 introduced in FIG. 3. The example fabric edge nodes 710, 720 can implement, e.g., the fabric edge nodes 113, 115 introduced in FIG. 1.

In example operations according to FIG. 7, the loop information reporter 711 at the fabric edge node 710 can report loop detection information 714 to the loop detector 702 at the controller 701, and the loop information reporter 721 at the fabric edge node 720 can report loop detection information 724 to the loop detector 702 at the controller 701. The loop detection information 714, 724 can comprise information according to any of the embodiments described herein, e.g., spanning tree topology information as described with reference to FIG. 2, BDPU information as described with reference to FIG. 3, or user plane data as described with reference to FIG. 5.

The loop detector 702 can process the loop detection information 714, 724 in order to determine the existence or possible existence of loop conditions involving a fabric overlay network comprising the controller 701 and the fabric edge nodes 710, 720. In some embodiments, multiple other fabric edge nodes may also report loop detection information to the controller 701 and the loop detector 702 may be configured to identify a loop involving any subset of the fabric edge nodes. Processing performed by the loop detector 702 can be configured according to any of the embodiments described herein, e.g., the loop detector 702 can be configured to compare spanning tree topology information, BDPU information, or user plane data.

In response to detecting a loop by loop detector 702, the controller 701 can activate the loop disabler 703 to disable the detected loop. The loop disabler 703 can generate reconfiguration information 740 and can provide the reconfiguration information 740 to a fabric edge node, e.g., to fabric edge node 710, in order to disable the loop. In some examples, the reconfiguration information 740 can cause the fabric edge node 710 to block or otherwise disable a port 713. The port 713 can be a port that is used in connection with the detected loop, e.g., a send or receive port via which loop communications are sent or received. The port 713 can be identified by the loop detection 702 based on the loop detection information 714. In some embodiments, the reconfiguration information 740 can block or disable a limited number, and less than all ports at the fabric edge node 710, which allows the fabric edge node 710 to continue normal operations with regard to the user of other ports, i.e., with regard to port 712.

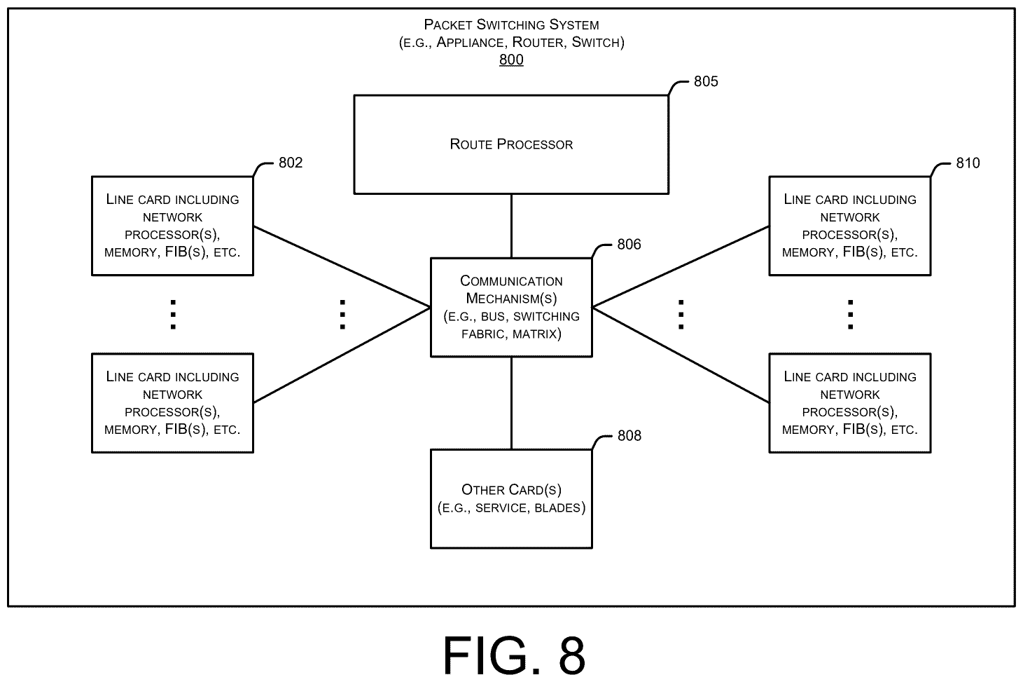

FIG. 8 illustrates an example packet switching system 800 that can be utilized to implement devices such as routers or other access point devices, in accordance with various aspects of the technologies disclosed herein. For example, the packet switching system 800 can implement any of the fabric overlay network nodes described herein. In some examples, the packet switching system 800 can be implemented as one or more packet switching device(s). The packet switching system 800 may be employed in a network, for example, the packet switching system 800 can implement a router configured to process network traffic by receiving and forwarding packets. The illustrated elements of the packet switching system 800 can include, e.g., components introduced in any of FIG. 7 to configure the packet switching system 800 to perform operations according to this disclosure.

In some examples, the packet switching system 800 may comprise multiple line card(s) 802, 810, each with one or more network interfaces for sending and receiving packets over communications links (e.g., possibly part of a link aggregation group). The packet switching system 800 may also have a control plane with one or more processing elements, e.g., the route processor 804 for managing the control plane and/or control plane processing of packets associated with forwarding of packets in a network. The packet switching system 800 may also include other cards 808 (e.g., service cards, blades) which include processing elements that are used to process (e.g., forward/send, drop, manipulate, change, modify, receive, create, duplicate, apply a service) packets associated with forwarding of packets in a network.

The packet switching system 800 may comprise a communication mechanism 806 (e.g., bus, switching fabric, and/or matrix, etc.) for allowing the different entities such as the multiple line card(s) 802, 810, the route processor 804, and the other cards 808 to communicate. The communication mechanism 806 can optionally be hardware-based. Line card(s) 802, 810 may perform the actions of being both an ingress and/or an egress line card of the line card(s) 802, 810, with regard to multiple packets and/or packet streams being received by, or sent from, the packet switching system 800.

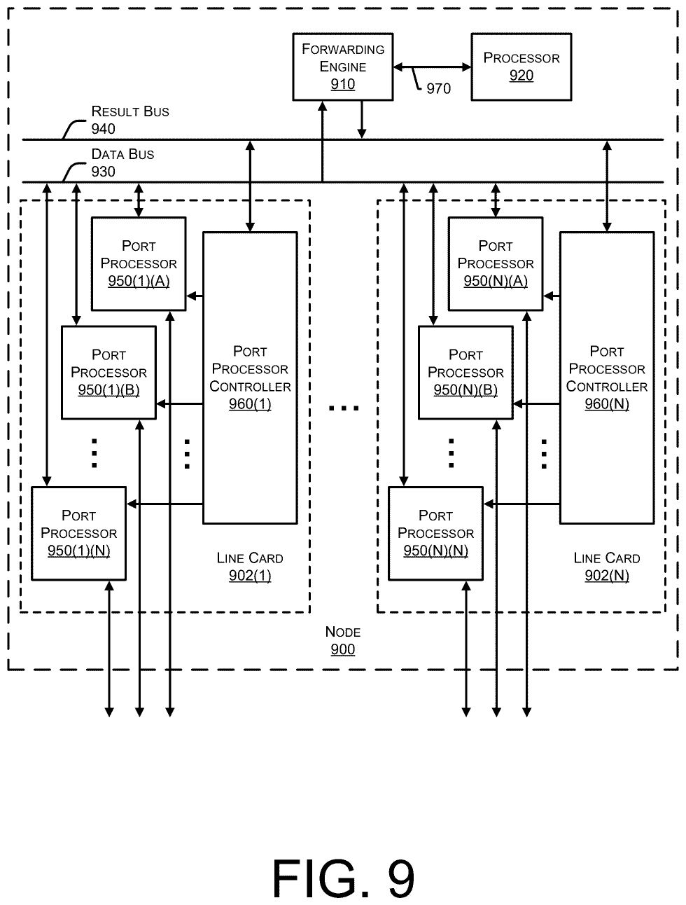

FIG. 9 illustrates an example node that can be utilized to implement devices in accordance with various aspects of the technologies disclosed herein. For example, the node 900 can implement any of the fabric overlay network nodes described herein. In some examples, node 900 may include any number of line cards 902, e.g., line cards 902(1)-(N), where N may be any integer greater than 1, and wherein the line cards 902 are communicatively coupled to a forwarding engine 910 (also referred to herein as an encryption engine) and/or a processor 920 via a data bus 930 and/or a result bus 940.

Line cards 902 may include any number of port processors 950, for example, line card 902(1) comprises port processors 950(1)(A)-950(1)(N), and line card 902(N) comprises port processors 950(N)(A)-950(N)(N). The port processors 950 can be controlled by port processor controllers 960, e.g., port processor controllers 960(1), 960(N), respectively.

Additionally, or alternatively, the forwarding engine 910 and/or the processor 920 can be coupled to one another via the data bus 930 and the result bus 940 and may also be communicatively coupled to one another by a communications link 970. The processors (e.g., the port processor(s) 950 and/or the port processor controller(s) 960) of each line card 902 may optionally be mounted on a single printed circuit board.

When a packet or packet and header are received, the packet or packet and header may be identified and analyzed by the node 900 in the following manner. Upon receipt, a packet (or some or all of its control information) or packet and header may be sent from one of port processor(s) 950 at which the packet or packet and header was received and to one or more of those devices coupled to the data bus 930 (e.g., others of the port processor(s) 950, the forwarding engine 910 and/or the processor 920). Handling of the packet or packet and header may be determined, for example, by the forwarding engine 910.

For example, the forwarding engine 910 may determine that the packet or packet and header should be forwarded to one or more of the other port processors 950. This may be accomplished by indicating to corresponding one(s) of port processor controllers 960 that a copy of the packet or packet and header held in the given one(s) of port processor(s) 950 should be forwarded to the appropriate other one of port processor(s) 950. Additionally, or alternatively, once a packet or packet and header has been identified for processing, the forwarding engine 910, the processor 920, and/or the like may be used to process the packet or packet and header in some manner and/or may add packet security information in order to secure the packet.

On a node 900 sourcing a packet or packet and header, processing may include, for example, encryption of some or all of the packet or packet and header information, the addition of a digital signature, and/or some other information and/or processing capable of securing the packet or packet and header. On a node 900 receiving a packet or packet and header, the processing may be performed to recover or validate the packet or packet and header information that has been secured.

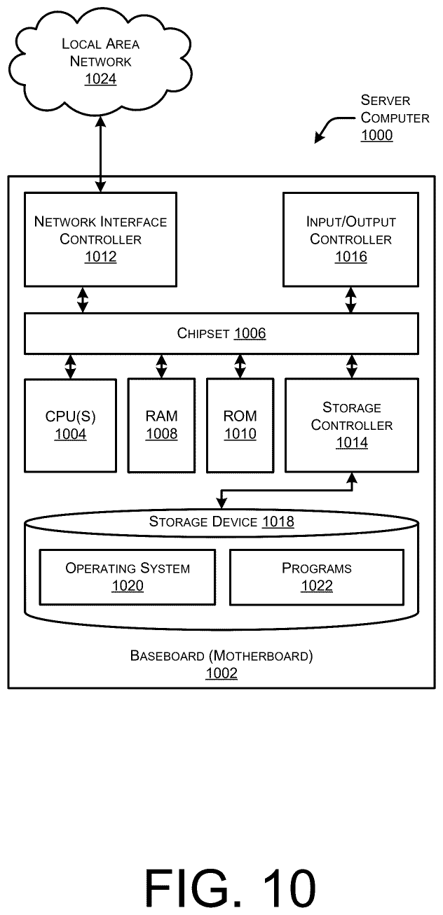

FIG. 10 illustrates an example computer hardware architecture that can implement devices in accordance with various aspects of the technologies disclosed herein. The computer architecture shown in FIG. 10 illustrates a conventional server computer 1000, however the computer architecture can optionally implement any other computing devices such as a router, a workstation, desktop computer, laptop, tablet, network appliance, e-reader, smartphone, or other computing device. The illustrated computer architecture can be utilized to execute any of the software components presented herein.

The server computer 1000 includes a baseboard 1002, or “motherboard,” which is a printed circuit board to which a multitude of components or devices can be connected by way of a system bus or other electrical communication paths. In one illustrative configuration, one or more central processing units (“CPUs”) 1004 operate in conjunction with a chipset 1006. The CPUs 1004 can be standard programmable processors that perform arithmetic and logical operations necessary for the operation of the server computer 1000.

The CPUs 1004 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1006 provides an interface between the CPUs 1004 and the remainder of the components and devices on the baseboard 1002. The chipset 1006 can provide an interface to a RAM 1008, used as the main memory in the server computer 1000. The chipset 1006 can further provide an interface to a computer-readable storage medium such as a read-only memory (“ROM”) 1010 or non-volatile RAM (“NVRAM”) for storing basic routines that help to start up the server computer 1000 and to transfer information between the various components and devices. The ROM 1010 or NVRAM can also store other software components necessary for the operation of the server computer 1000 in accordance with the configurations described herein.

The server computer 1000 can operate in a networked environment using logical connections to remote computing devices and computer systems through a network, such as the LAN 1024. The chipset 1006 can include functionality for providing network connectivity through a NIC 1012, such as a gigabit Ethernet adapter. The NIC 1012 is capable of connecting the server computer 1000 to other computing devices over the LAN 1024. It should be appreciated that multiple NICs 1012 can be present in the server computer 1000, connecting the computer to other types of networks and remote computer systems.

The server computer 1000 can be connected to a storage device 1018 that provides non-volatile storage for the server computer 1000. The storage device 1018 can store an operating system 1020, programs 1022, and data, to implement any of the various components described in detail herein.

The storage device 1018 can be connected to the server computer 1000 through a storage controller 1014 connected to the chipset 1006. The storage device 1018 can comprise one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server computer 1000 can store data on the storage device 1018 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 1018 is characterized as primary or secondary storage, and the like.

For example, the server computer 1000 can store information to the storage device 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server computer 1000 can further read information from the storage device 1018 by detecting the physical states or characteristics of one or more particular locations within the physical storage units.

In addition to the mass storage device 1018 described above, the server computer 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the server computer 1000. In some examples, the operations performed by the computing elements illustrated in FIGS. 1-3, and or any components included therein, may be supported by one or more devices similar to server computer 1000.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 1018 can store an operating system 1020 utilized to control the operation of the server computer 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 1018 can store other system or application programs and data utilized by the server computer 1000.

In one embodiment, the storage device 1018 or other computer-readable storage media is encoded with computer-executable instructions which, when loaded into the server computer 1000, transform the computer from a general-purpose computing system into a special-purpose computer capable of implementing the embodiments described herein. These computer-executable instructions transform the server computer 1000 by specifying how the CPUs 1004 transition between states, as described above.

According to one embodiment, the server computer 1000 has access to computer-readable storage media storing computer-executable instructions which, when executed by the server computer 1000, can implement the architectures and perform the various processes described with regard to FIGS. 1-7. The server computer 1000 can also include computer-readable storage media having instructions stored thereupon for performing any of the other computer-implemented operations described herein.

The server computer 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can provide output to a display, such as a computer monitor, a flat panel display, a digital projector, a printer, or other type of output device. It will be appreciated that the server computer 1000 might not include all of the components shown in FIG. 10, can include other components that are not explicitly shown in FIG. 10, or might utilize an architecture completely different than that shown in FIG. 10.

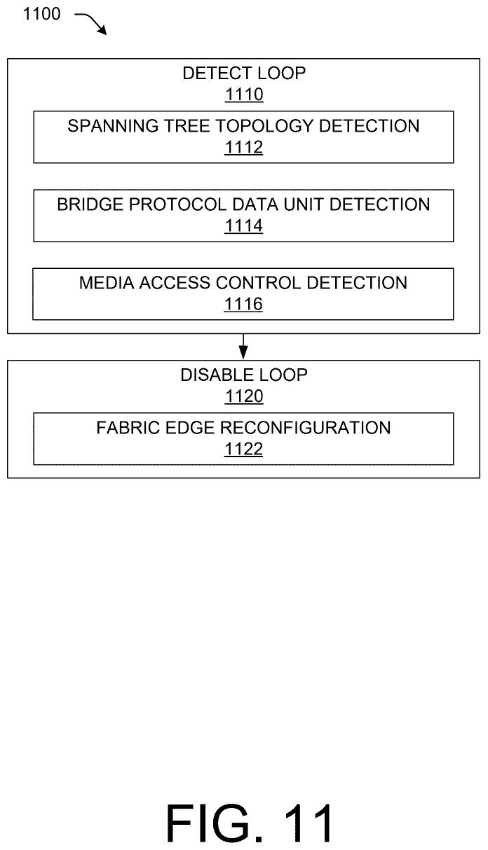

FIG. 11 is a flow diagram of an example method 1100 performed at least partly by a computing device, such as the server computer 1000, optionally in conjunction with other computing devices such as the packet switching system 800 or the node 900. The logical operations described herein with respect to FIG. 11 may be implemented (1) as a sequence of computer-implemented acts or program modules running on a computing system and/or (2) as interconnected machine logic circuits or circuit modules within the computing system. In some examples, the method 1100 may be performed by a system comprising one or more processors and one or more non-transitory computer-readable media storing computer-executable instructions that, when executed by the one or more processors, cause the one or more processors to perform the method 1100.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof.

It should also be appreciated that more or fewer operations might be performed than shown in FIG. 11 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by fewer components, more components, different components, or any configuration of components.

FIG. 11 is a flow diagram that illustrates an example overlay network loop detection and prevention method, in accordance with various aspects of the technologies disclosed herein. In an example embodiment, the illustrated method can be performed at fabric overlay controller or a control plane node associated with a fabric overlay network. The fabric overlay controller, or the control plane node can be implemented for example by a controller 701 such as illustrated in FIG. 7.

At operation 1110, the controller 701 can detect a loop involving a fabric overlay network 110. For example, the controller 701 can detect a loop 130 among multiple networked entities, the multiple network entities comprising a fabric overlay network 110, a first data link layer switch 121, and a second data link layer switch 122. The first data link layer switch 121 and the second data link layer switch 122 are coupled externally of the fabric overlay network 110, and the first data link layer switch 121 and the second data link layer switch 122 can comprise, e.g., ethernet switches. The loop 130 detected at operation 1110 can comprise a configuration of the fabric overlay network 110, the first data link layer switch 121, and the second data link layer switch 122 which enables forwarding network packets in multiple redundant traverses of the fabric overlay network 110, the first data link layer switch 121, and the second data link layer switch 122. The operation 1110 can optionally be configured according to any of multiple options, including operations 1112, 1114, and 1116. In some embodiments, a fabric overlay network 110 can be configured to perform multi-modal loop detection according to multiple of operations 1112, 1114, and 1116.

In an example, loop detection according to operation 1110 can optionally comprise spanning tree topology detection according to operation 1112. At operation 1112, detecting the loop 130 among the multiple networked entities (including the fabric overlay network 110, the first data link layer switch 121, and the second data link layer switch 122) can comprise sending, by a fabric edge component such as fabric edge node 113, spanning tree topology information 211 to a fabric overlay network controller such as the fabric controller 201. The fabric controller 201 can be configured to detect the loop 130 based on the spanning tree topology information 211, by comparing the spanning tree topology information 211 with other spanning tree topology information 212, 213 received from other fabric edge components of the fabric overlay network, such as the fabric edge nodes 114, 115. The spanning tree topology information 211, 212, 213 can comprise bridge identifiers associated with the fabric edge nodes 113, 114, 115 and VLAN identifiers associated with the fabric edge nodes 113, 114, 115.

In another example, loop detection according to operation 1110 can optionally comprise bridge protocol data unit detection according to operation 1114. At operation 1114, detecting the loop 130 among the multiple networked entities can comprise sending, by a fabric edge component such as fabric edge node 113, BDPU information 301 to a control plane node 311 associated with the fabric overlay network 110, wherein the control plane node 311 is configured to detect the loop 130 based on a comparison of the BDPU information 301 with other BDPU information 302 received from at least one other fabric edge component, such as the fabric edge nod 115.

In another example, loop detection according to operation 1110 can optionally comprise media access control detection according to operation 1116. At operation 1116, detecting the loop 130 among the multiple networked entities can comprise detecting the loop 130 based on a comparison of MAC information included in user plane data 501, 502 (e.g., user plane data packets) processed by the fabric edge node 113 and at least one other fabric edge node 115.

Operation 1120 can comprise disabling a loop 130. Operation 1120 can be performed in response to detecting a loop 130 at operation 1110, regardless of which of the operations 1112, 1114, 1116 detects the loop 130. In an example, operation 1120 can comprise modifying at least one fabric edge component, e.g., the fabric edge node 113 of the fabric overlay network 110 to disable the loop 130.

The modifying conducted at operation 1120 can optionally comprise fabric edge reconfiguration at operation 1122. Operation 1122 can be adapted to reconfigure the at least one fabric edge node 113 to block network packets communicated between the fabric edge node 113 and the first data link layer switch 121. Operation 1122 can optionally comprise reconfiguring the at least one fabric edge node 113 to block the network packets communicated between the fabric edge node 113 and the first data link layer switch 121 by blocking a port of the at least one fabric edge node 113.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method, comprising:
detecting a loop among multiple networked entities, the multiple network entities comprising a fabric overlay network, a first data link layer switch, and a second data link layer switch,
wherein the first data link layer switch and the second data link layer switch are coupled externally of the fabric overlay network, and
wherein the loop enables forwarding network packets in multiple redundant traverses of the fabric overlay network, the first data link layer switch, and the second data link layer switch; and
in response to detecting the loop, modifying at least one fabric edge component of the fabric overlay network to disable the loop, wherein the modifying comprises reconfiguring the at least one fabric edge component to block network packets communicated between the fabric edge component and the first data link layer switch.

2. The method of claim 1, wherein detecting the loop among the multiple networked entities comprises sending, by the fabric edge component, spanning tree topology information to a fabric overlay network controller, wherein the fabric overlay network controller is configured to detect the loop based on the spanning tree topology information.

3. The method of claim 2, wherein the spanning tree topology information comprises a bridge identifier associated with the fabric edge component and a virtual local area network identifier associated with the fabric edge component.

4. The method of claim 2, wherein the fabric overlay network controller is adapted to detect the loop based on the spanning tree topology information by comparing the spanning tree topology information with other spanning tree topology information received from another fabric edge component of the fabric overlay network.

5. The method of claim 2, wherein the fabric overlay network controller is adapted to reconfigure the at least one fabric edge component to block the network packets communicated between the fabric edge component and the first data link layer switch by blocking a port of the at least one fabric edge component.

6. The method of claim 1, wherein detecting the loop among the multiple networked entities comprises sending, by the fabric edge component, bridge protocol data unit information to a control plane node associated with the fabric overlay network, wherein the control plane node is configured to detect the loop based on a comparison of the bridge protocol data unit information with other bridge protocol data unit information received from at least one other fabric edge component.

7. The method of claim 1, wherein detecting the loop among the multiple networked entities comprises detecting the loop based on a comparison of media access control information included in user plane data packets processed by the fabric edge component and at least one other fabric edge component.

8. The method of claim 1, wherein the first data link layer switch and the second data link layer switch comprise ethernet switches.

9. A device comprising:
one or more processors; and
one or more non-transitory computer-readable media storing computer-executable instructions that, when executed by the one or more processors, cause the one or more processors to perform operations comprising:
detecting a loop among multiple networked entities, the multiple network entities comprising a fabric overlay network, a first data link layer switch, and a second data link layer switch,
wherein the first data link layer switch and the second data link layer switch are coupled externally of the fabric overlay network, and
wherein the loop enables forwarding network packets in multiple redundant traverses of the fabric overlay network, the first data link layer switch, and the second data link layer switch; and
in response to detecting the loop, modifying at least one fabric edge component of the fabric overlay network to disable the loop, wherein the modifying comprises reconfiguring the at least one fabric edge component to block network packets communicated between the fabric edge component and the first data link layer switch.

10. The device of claim 9, wherein detecting the loop among the multiple networked entities comprises sending, by the fabric edge component, spanning tree topology information to a fabric overlay network controller, wherein the fabric overlay network controller is configured to detect the loop based on the spanning tree topology information.

11. The device of claim 10, wherein the spanning tree topology information comprises a bridge identifier associated with the fabric edge component and a virtual local area network identifier associated with the fabric edge component.

12. The device of claim 10, wherein the fabric overlay network controller is adapted to detect the loop based on the spanning tree topology information by comparing the spanning tree topology information with other spanning tree topology information received from another fabric edge component of the fabric overlay network.

13. The device of claim 10, wherein the fabric overlay network controller is adapted to reconfigure the at least one fabric edge component to block the network packets communicated between the fabric edge component and the first data link layer switch by blocking a port of the at least one fabric edge component.

14. The device of claim 9, wherein detecting the loop among the multiple networked entities comprises sending, by the fabric edge component, bridge protocol data unit information to a control plane node associated with the fabric overlay network, wherein the control plane node is configured to detect the loop based on a comparison of the bridge protocol data unit information with other bridge protocol data unit information received from at least one other fabric edge component.

15. The device of claim 9, wherein detecting the loop among the multiple networked entities comprises detecting the loop based on a comparison of media access control information included in user plane data packets processed by the fabric edge component and at least one other fabric edge component.

16. The device of claim 9, wherein the first data link layer switch and the second data link layer switch comprise ethernet switches.

17. A method comprising:
detecting a loop among multiple networked entities, the multiple network entities comprising a fabric overlay network, a first ethernet switch, and a second ethernet switch,
wherein the loop enables forwarding network packets in multiple redundant traverses of the fabric overlay network, the first ethernet switch, and the second ethernet switch; and
in response to detecting the loop, reconfiguring at least one fabric edge component of the fabric overlay network to block network packets communicated between the fabric edge component and the first ethernet switch.

18. The method of claim 17, wherein detecting the loop among the multiple networked entities comprises sending, by the fabric edge component, spanning tree topology information to a fabric overlay network controller, wherein the fabric overlay network controller is configured to detect the loop based on the spanning tree topology information.

19. The method of claim 17, wherein detecting the loop among the multiple networked entities comprises sending, by the fabric edge component, bridge protocol data unit information to a control plane node associated with the fabric overlay network, wherein the control plane node is configured to detect the loop based on a comparison of the bridge protocol data unit information with other bridge protocol data unit information received from at least one other fabric edge component.

20. The method of claim 17, wherein detecting the loop among the multiple networked entities comprises detecting the loop based on a comparison of media access control information included in user plane data packets processed by the fabric edge component and at least one other fabric edge component.
